(19) United States
(12) Patent Application Publication
(10) Pub. No.: US 2024/0081200 A1
(43) Pub. Date: Mar. 14, 2024

(54) DEVICE TO SECURE A LANDSCAPING STRUCTURE

(71) Applicant: Lisa Brooks, Chicago, IL (US)

(72) Inventor: Lisa Brooks, Chicago, IL (US)

(21) Appl. No.: 17/942,830

(22) Filed: Sep. 12, 2022

(51) Int. Cl. A01G 9/28

(52) U.S. Cl. CPC A01G 9/28

(57) ABSTRACT

A landscape edging device for fixing landscape edging lumber, the landscape edging device includes a crown portion, a left leg, and a right leg. Wherein the left leg and the right leg are perpendicular to the crown portion. The lower ends of the left leg and the right leg are tapered to form a pointed edge. The crown portion, the left leg, and the right leg can wrap around the three sides of the lumber and the two legs penetrate the ground securing the lumber.

### CROSS-REFERENCE TO RELATED APPLICATIONS

This application claims priority from a U.S. Provisional Patent Appl. No. 63/244,110 filed on Sep. 14, 2021, which is incorporated herein by reference in its entirety.

### FIELD OF INVENTION

The present invention relates to landscape edging staples, and more particularly, the present invention relates to a device for fixing landscape edging structures or barriers.

### BACKGROUND

Landscape edging is a primary step in preparing landscape paths and garden beds. A variety of materials are known for use in landscape edging that offer a variety of advantages. Long wooden lengths of lumber are a quick and easy way to create landscape edging. However, securing the lumber is still a laborious, risky, and time-consuming process. Generally, landscape spikes, which are essentially long metal nails, are used as fasteners for attaching natural wood products to the ground for use as landscape edging. The landscape spikes are used with landscape timbers that are typically available in 4″×4″, 4″×6″, and 6″×6″ size in various lengths with rounded edges or straight edges. An alternate option is to use railroad ties with the spikes; however, the railroad ties can be hazardous to health if they haven't been treated to remove harmful chemicals. Both the landscape timber and railroad ties typically require digging to level the timbers on the ground and require drilling holes through the timbers so that landscape spikes can be driven through the timber and into the ground to keep everything in place. Thus, the process is laborious, time-consuming, and can result in injury to persons managing the installation and/or nearby persons. Furthermore, the aesthetic result of using typical landscape lumber is limited to lumber that is four-inches wide or wider.

A need is, therefore, created for a device for installing wooden lumber for landscape edging that is devoid of the drawbacks of the known fastener types.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a device for installing landscape edging using lengths of lumber quickly and easily.

It is another object of the present invention that only a rubber mallet is needed for installation.

It is still another object of the present invention that the need for drilling and digging is not necessary.

It is a further object of the present invention that the device provides an aesthetic value.

It is a further object of the present invention that the device can withstand harsh conditions and external shocks.

It is still a further object of the present invention that the device is economical to manufacture.

In one aspect, disclosed is a device for fixing lumber as landscape edging, the device comprises a crown portion that has a proximal end and a distal end; and a left leg and a right leg that extend from the proximal end and the distal end respectively, wherein inner surfaces of the left leg and the right leg face each other, and the left leg and the right leg are spatially spaced apart and parallel to each other, each of the left leg and the right leg has its lower end tapered to form a pointed end. The length of the crown portion is equal to or slightly larger than the width of the lumber. The crown portion is square. The widths of the left leg and the right leg are equal to the length of the crown portion. Each of the left leg and the right leg is about 8-11 inches long. Each of the left leg and the right leg is perpendicular to the crown portion. All of the crown portion, the left leg, and the right leg have a flat profile. The crown portion, the left leg, and the right leg are integral and made from a metal sheet.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person equipped with the relevant knowledge, skills, and tools to use the invention.

FIG. 1 is a perspective view of a device, according to an exemplary embodiment of the present invention.

FIG. 2 is a side view of the device, according to an exemplary embodiment of the present invention.

FIG. 3 shows lumber fixed on the ground using the disclosed device, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed is a device for fixing lengths of lumber to the ground for landscape edging. The disclosed device can secure the lumber in place on the ground. The disclosed device can wrap around the lumber and penetrate the ground for securing the lumber using a hammer or rubber mallet only.

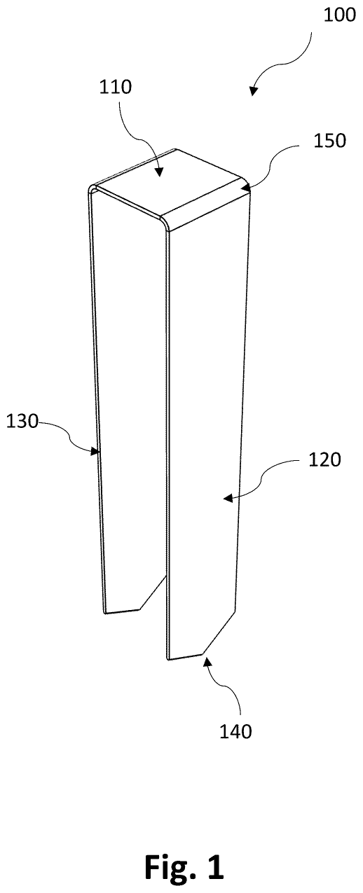

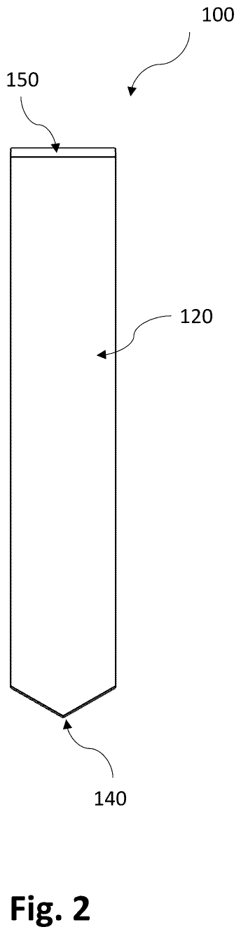

Referring to FIGS. 1 and 2 show a perspective view and a side view of the disclosed device 100 respectively. Device 100 includes a crown portion 110, a first leg 120 that extends from a proximal end of the crown portion, and a second leg 130 that extends from a distal end of the crown portion. The crown, the first leg, and the second leg can be integrally formed as a single unit. The disclosed device can be manufactured from a metal plate, such as a steel plate.

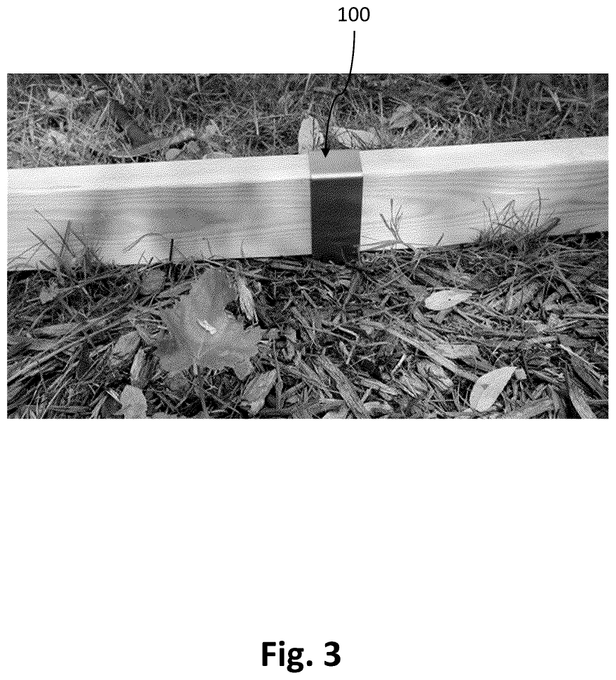

The crown portion can have a flat and elongated profile, wherein the length of the crown portion can be equal to or at least more than the width of the lumber. The first leg and the second leg are also flat and elongated. The lower ends of the first leg and the second leg can be tapered to form a pointed edge 140. The pointed edge allows the two legs to penetrate the ground. For installation, the crown portion and upper portions of the two legs wrap around the top and sides of the lumber placed on the ground, while the lower portions of the two legs insert into the ground, as shown in FIG. 3. A rubber mallet can be used to force the device into the ground, wherein the crown portion of the device can be hit by the rubber mallet.

For installation, the device can be placed around “two by” lumber, such as a “two-by-four”, or “2×4” (lumber that is 2″ high by 4″ wide), when the lumber is placed on the ground. The two legs of the device through their pointed edges can be forcibly inserted into the ground by hitting the crown portion with a mallet for securing the lumber. The lumber can be stabilized on the ground by the device, wherein the lumber can hold landscaping material, such as mulch, gravel, rocks, and dirt in place. No digging or drilling is needed. The device wraps around the lumber and secures it to the ground on both sides of the lumber so there is no need to drill through the lumber. Moreover, the installed lumber is held in an upright position, 90 degrees to the ground, by design so that it cannot slump over or fall on its side. It is particularly advantageous that the disclosed device can be used to install “two by” lumber. “Two by” lumber is amply available lumber that is commonly used in building construction, for example, in exterior building applications such as decks, sheds, and carports, where lumber suitable for exterior use is required. “Two by” lumber is essentially half of the width of typical landscape lumber. This decreased workable material size can put persons who have an aesthetic preference or technical requirement for the slimmer profile of “two by” lumber more at risk of injury should they opt to drill holes in the “two by” lumber to secure it to the ground with pegs/nails/stakes.

The disclosed device can be adapted to a variety of “two by” lumber sizes so that consumers have a range of choices for natural wood edging including easy and accurate installation of “two by” lumber, perpendicular to the ground. The disclosed device has a thin profile, and combined with “two by” lumber, the disclosed device more readily blends into the landscape providing a finished appearance that is markedly different from typical landscape lumber. The width of the crown and legs can be about 1-2 inches for desired durability and rigidity of the device.

The crown portion can have a flat profile, the inner surfaces of the two legs can face each other and the two legs can be spatially apart and run parallel to each other. The two legs can extend perpendicular to the crown in the same direction. The device can be made from rigid and durable materials, such as metals. Iron, steel, and the like can be used. The two legs have an elongated and straight profile with a pointed tapered end that allows the device to be driven into the ground using a rubber mallet without deformation, bending, or buckling of the device.

The disclosed device can be made from a flat sheet of suitable material, such as steel by stamping or a like process. The two legs can be made by bending wherein the ends of the legs can be tapered and sharpened for a pointed edge. This makes the process economical and easy to scale up. As shown in the drawings, the flat surface of the two legs can face each other. The two legs can be perpendicular to the crown for uniform distribution of the force and to resist deforming, buckling, or bending when hammered. Suitable caps can be provided for the pointed ends of the device for storage and transportation of the device, wherein the caps can protect the pointed end of the device.

Referring to FIG. 1, the bends, also referred to herein as shoulders 150 can be rounded, so that a distance between the inner surfaces of the two legs can be slightly more than the length of the crown portion. The rounded bends allow uniform transfer of the force of the hammer on the crown to the two legs. In one implementation, the crown can be flat and square. Each side of the square crown portion can be about 1.5 to 2.0 inches, and more preferably, about 1.75 inches. The legs can be about 8-12 inches long, and more preferably 9-11 inches long. The width of the legs can be the same as the width of the crown portion.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. A stand-alone device for fixing two-by lumber as landscaping edging around an area, the device comprises:
a crown portion that has a proximal end and a distal end; and
a left leg and a right leg that extend from the proximal end and the distal end respectively, wherein inner surfaces of the left leg and the right leg face each other, and the left leg and the right leg are parallel to each other, each of the distal ends of the left leg and right leg being tapered to form a pointed end wherein said crown portion of said device fits over a top of a piece of two-by lumber and said left leg and said right leg straddle a first side and a second side of said piece of two-by lumber.

2. The device according to claim 1, wherein a length of the crown portion is equal to or greater than a width of the lumber

3. The device according to claim 2, wherein the crown portion is square.

4. The device according to claim 3, wherein widths of the left leg and the right leg are equal to the length of the crown portion.

5. The device according to claim 4, wherein each of the left leg and the right leg is about 8-11 inches long.

6. The device according to claim 1, wherein each of the left leg and the right leg is perpendicular to the crown portion.

7. The device according to claim 1, wherein each of the crown portion, the left leg, and the right leg has a flat profile.

8. The device according to claim 1, wherein the crown portion, the left leg, and the right leg are integral and made from a metal sheet.

9. A method for fixing two-by lumber as landscape edging around an area, the method comprises: providing a stand-alone device comprising: a crown portion that has a proximal end and a distal end; and a left leg and a right leg that extend from the proximal end and the distal end respectively, wherein inner surfaces of the left leg and the right leg face each other, and the left leg and the right leg are parallel to each other, each of the distal ends of the left leg and right being tapered to form a pointed end wherein said crown portion of said device fits over a top of a piece of two-by lumber and said left leg and said right leg straddle a first side and a second side of said piece of two-by lumber; providing a piece of two-by lumber; setting said piece of two-by lumber around a specified area for landscaping; placing said device over said piece of two-by lumber such that said crown portion sits atop a top portion of said piece of two-by lumber and said left leg and said right leg straddle said piece of two-by lumber; and applying force to said crown portion to secure said piece of two-by lumber into the ground around said specified area for landscaping.

10. The method according to claim 9, wherein a length of the crown portion is equal to or greater than a width of the lumber.

11. The method according to claim 10, wherein the crown portion is square.

12. The method according to claim 11, wherein widths of the left leg and the right leg are equal to the length of the crown portion.

13. The method according to claim 12, wherein each of the left leg and the right leg is about 8-11 inches long.

14. The method according to claim 9, wherein each of the left leg and the right leg is perpendicular to the crown portion.

15. The method according to claim 9, wherein each of the crown portion, the left leg, and the right leg has a flat profile.

16. The method according to claim 9, wherein the crown portion, the left leg, and the right leg are integral and made from a metal sheet.
